(19) United States
(12) Patent Application Publication
(10) Pub. No.: US 2012/0065775 A1
(43) Pub. Date: Mar. 15, 2012

(54) REFRIGERATED SOLID FRONT VENDING MACHINE AND METHOD OF OPERATION

(75) Inventors: Kevin Ward, St. Louis, MO (US); Ronald A. Hoormann, St. Charles, MO (US); Bradley A. Wiedlocher, St. Louis, MO (US)

(73) Assignee: Coin Acceptors, Inc., St. Louis, MO (US)

(21) Appl. No.: 13/049,881

(22) Filed: Mar. 16, 2011

Related U.S. Application Data
(60) Provisional application No. 61/314,283, filed on Mar. 16, 2010.

(51) Int. Cl. G07F 11/00

(52) U.S. Cl. 700/232

(57) ABSTRACT

A vending machine and a method of use having a solid front. The solid front has an inner and outer surface. The solid front defined a plurality of product selection areas, each of the product selection areas associated with a product vendable by said vending machine. A plurality of sense electrodes are placed on the inner surface of the solid front of the vending machine, each of said electrodes associated with one of the product selection areas. The sense electrodes are physically isolated from the outer surface of the solid front by the solid front. A circuit electrically connects to the sense electrodes and determined whether a customer has contacted the outer surface in one of the product selection areas. The circuit communicates information indicating that a product selection area has been touched to a vending machine controller, and the vending machine vends the product.

This application for patent claims priority to U.S. Provisional Patent Application Ser. No. 61/314,283 filed Mar. 16, 2010. The contents of said application are incorporated herein by reference.

### FIELD OF THE INVENTION

The present invention is related to the field of vending machines. More specifically, the present invention is related to a vending machine that eliminates buttons and keypads for product selection.

### BACKGROUND OF THE INVENTION

The invention resides in a vending machine for providing and delivering refrigerated products contained in containers, the vending machine including a storage space and a dispensing compartment. The solid front of the vending machine typically comprises a double door for better thermal insulation for delivering refrigerated product.

The viewing of selectable products from within a solid front vending machine typically includes a number of spaced apart graphics representing the available products depicted on the surface of the solid front door and are illuminated from the inner side.

In the past, a customer would enter the identification associated with one of the many products within a solid front vendor by making a two digit entry on a keypad or by depressing independent selection buttons located on one side of the vending machine. The buttons constitute physical button that are attached to structure behind the solid front or the solid front itself and extend through an opening within the solid front of the vending machine.

The customer selects from among the depicted products by depressing designated selection buttons located off to one side of the viewing area, and having entered sufficient credit for the selection receives the vended product.

Such beverage vending machines are known in the art and are generally used for dispensing bottled or canned beverages or food items.

However, keypads add a level of complexity both in operating and also constructing a vending machine. Keypads can easily malfunction leaving a number of products unavailable that rely on a malfunctioning digit and keypads can be hard to clean and generally unsanitary. Additionally, because user press the digits of the keypad many thousands of times, printed indicia on the keys can become worn and obscured, which gives an old or unclean appearance. Additionally, mechanical buttons or switches will wear and become unsightly. Also, such mechanical devices give an old or antiquated feeling that is typically incompatible with the marketing approach of many beverage companies who tend to desire to portray the image of young, new and exciting.

Therefore, there is a need in the art for a vending machine that eliminates mechanical buttons and keypads, increases ease and simplicity of use and construction of the vending machine, promotes cleanliness and a cleanly appearance of the machine, and also improves the machine's appearance to give a more modern, unique and exciting appearance in comparison with traditional vending machines.

### SUMMARY OF THE INVENTION

A vending machine and a method of use having a solid front. The solid front has an inner and outer surface. The solid front defined a plurality of product selection areas, each of the product selection areas associated with a product vendable by said vending machine. A plurality of sense electrodes are placed on the inner surface of the solid front of the vending machine, each of said electrodes associated with one of the product selection areas. The sense electrodes are physically isolated from the outer surface of the solid front by the solid front. A circuit electrically connects to the sense electrodes and determined whether a customer has contacted the outer surface in one of the product selection areas. The circuit communicates information indicating that a product selection area has been touched to a vending machine controller, and the vending machine vends the product.

### BRIEF DESCRIPTION OF THE DRAWINGS

FIG. 1 is a front perspective view of a vending machine according to the prior art;

FIG. 2 is a front perspective view of another vending machine according to the prior art;

FIG. 3 is a front view of a vending machine according to an embodiment of the present invention;

FIG. 4 is a front view of a vending machine according to an embodiment of the present invention;

FIG. 5 is a diagrammatic cross sectional side view of a solid front of a vending machine according to an embodiment of the present invention;

FIGS. 6, 7, and 8 are depictions of various types of sense electrodes attached on an inner surface of the solid front of a vending machine according to an embodiment of the present invention;

FIG. 9 is a circuit diagram depicting a sense electrode circuit according to an embodiment of the present invention;

FIG. 10 is a circuit diagram of a vending machine according to an embodiment of the present invention;

FIG. 11 is a circuit diagram of a vending machine according to another embodiment of the present invention; and

FIG. 12 is a circuit diagram of a vending machine according to yet another embodiment of the present invention.

### DETAILED DESCRIPTION OF THE INVENTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

In the preferred embodiment of the present invention, there is a simple method to utilize the graphics located on the solid front of a vending machine to represent the available products in the machine and for making product selections. Additionally, the customer is provided with product availability information directly with the graphic depiction of each product.

Referring to the figures there is generally illustrated therein a preferred embodiment of a solid front vending machine that incorporates the principles of this invention. While the preferred embodiment of this invention will be described with its applicability to a solid front vending machine for refrigerated products, it will be understood that the broad principles of the invention are not limited to such product selection application or to the specifics of the preferred embodiment disclosed. The described disclosure represents one clear example of a selection system incorporating the principles of the claimed invention, but the invention is not intended to be construed in a limiting manner as a result of the preferred embodiment disclosure.

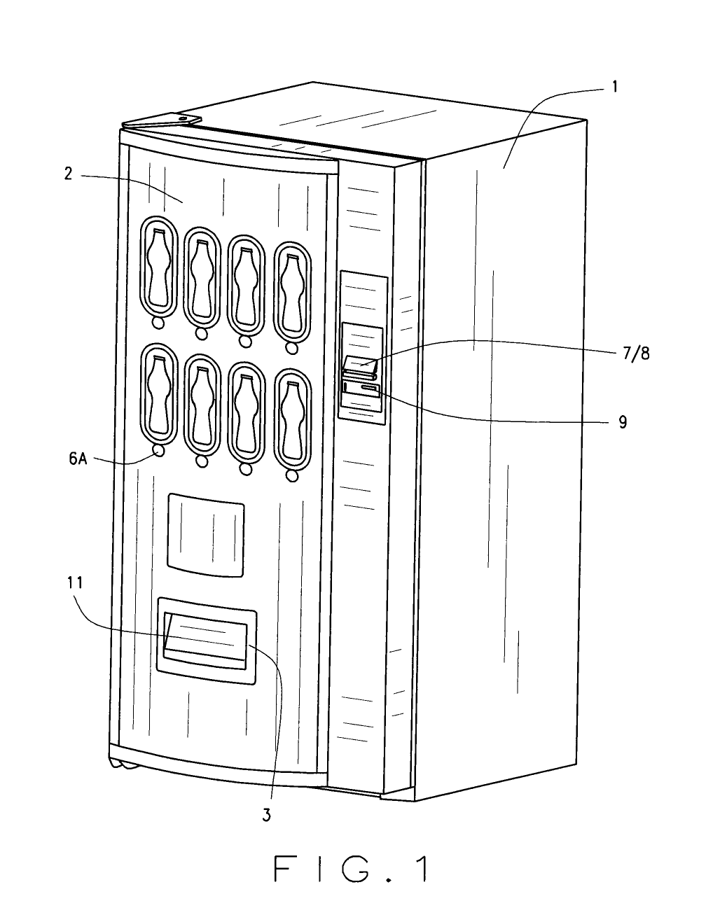

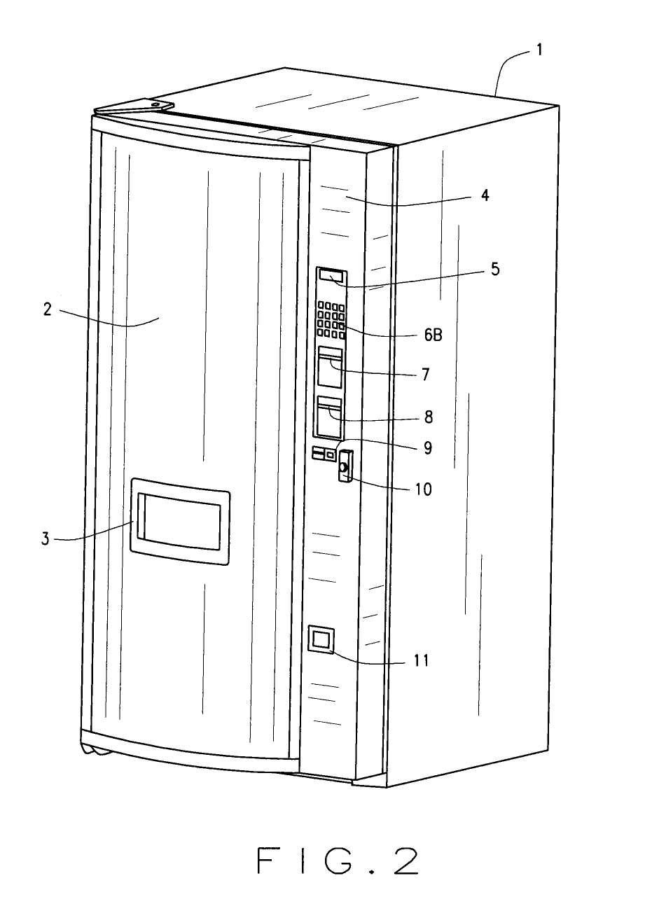

Referring now to FIG. 1 and FIG. 2 there is generally illustrated a vending machine 1 having a solid front 2. In FIG. 1, images of the products available for vending from the machine are placed on the solid front 2 with selection buttons 6A. Alternatively in FIG. 2, a keypad 6B for making a numeric entry for selecting a product is provided. Credit entry portions 7 and 8 allow for depositing bills (banknotes) and/or validating credit and debit cards. A coin entry portion 9 accepts coins for credit, and a product delivery port 3 provides access to vended product. A coin return 11 provides a location for change to be provided in the form of coins. A customer typically determines available products by viewing the display 5 and after an appropriate selection has been made by pressing a selection button 6A or by entering the appropriate code on the keypad 6B, if the amount deposited by consumer equals or exceeds the cost of the product selected, then the vending machine transfers the product to the customer to the product delivery port 3.

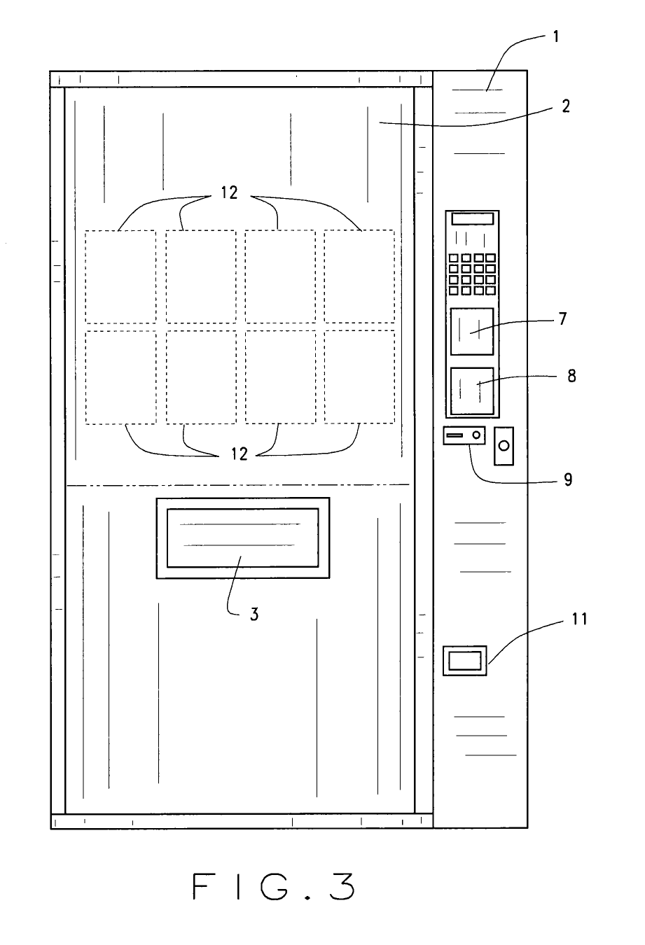

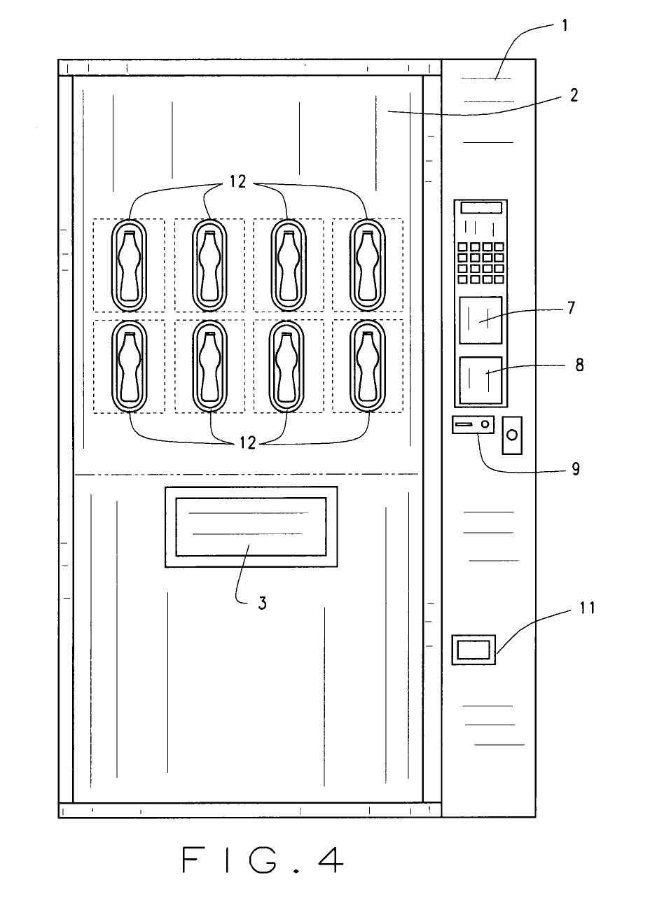

Referring now to FIGS. 3 and 4 wherein there are product sensors 12, which may include graphics, depicted on the solid front 2 of the vending machine 1. The product sensors 12 placed thereon are for a customer to select a product by directly touching it. In the present example, eight product sensors 12 are shown arranged in two rows. The graphics of the product sensors 12 in FIG. 4 depict the actual product; the graphics of the product sensors 12 in FIG. 3 are generic and could name the product, represent it numerically or otherwise display it without a depiction of the actual product.

A cross sectional side view of FIG. 5 depicts a sensitive area 14 of a selectable product sensor 12 and shows a customer finger 16 touching it. When the finger 16 touches the outer side of the door pane it comes sufficiently close to a sense electrode 18 located on an inner side of the vending machine front 2 to activate the touch sensor as described in further detail below. The sense electrode 18 is mounted on the inner side of the vending machine front 2 just behind the graphical depiction or other representation of the product on the front of the vending machine 1 such that the sense electrode 18 is generally not visible to the consumer. The consumer gets the feeling that he customer is merely touching the face of the vending machine rather than interacting with a keypad or button. The customer gains a feeling of interacting with the entire machine by merely touching the surface of the solid front 2 of the vending machine 1 to indicate the customer's choices. In this manner, the customer is not presented with a moveable buttons or keypads as in prior art vending machines. Additionally, the look and feel of the vending machine can be made to appear more modern and clean. Buttons which can build up grime or a dirty appearance from the fingerpresses of thousands of customers and the exposure to the elements if not properly cleaned are avoided. Moreover, the front surface 2 of the vending machine 1 is more easily manufactured from an uncomplicated monolithic surface.

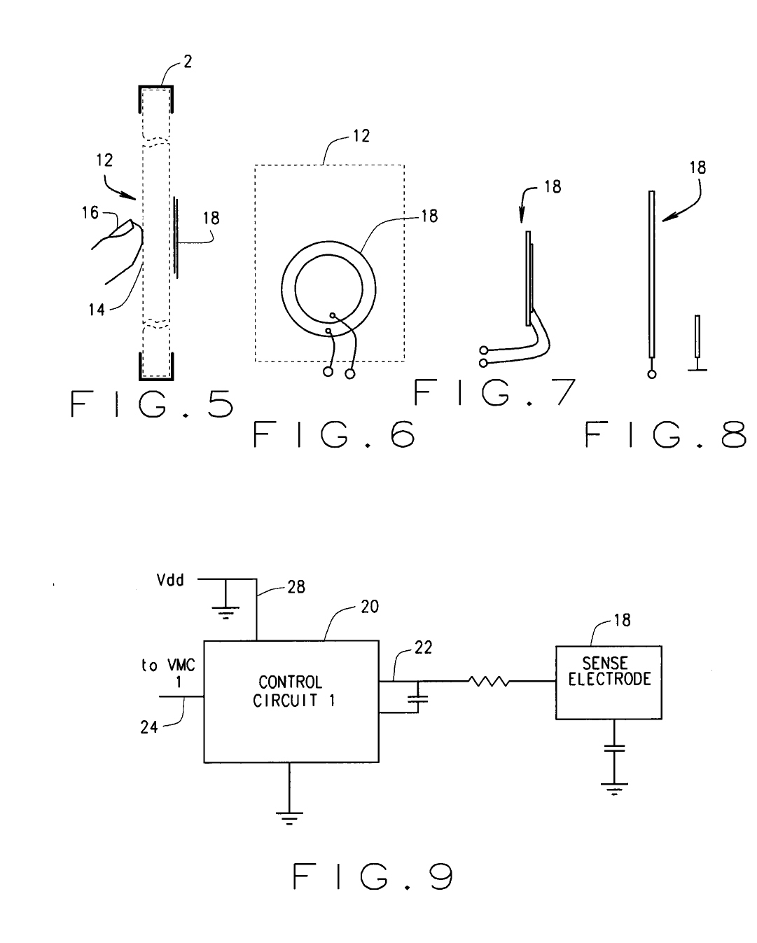

A preferred sense electrode 18 is shown in FIG. 9. The sense electrode 18 is shown in relation to the selectable product sensor area 12 and is configurable to determine its sensitivity. Moreover, its location and geometrical dimensions versus the selectable product sensors area as well as the thickness of the door panel determine what portion of the selectable product sensor area 12 is sensitive to the presence of human touch, such as the finger 16. Preferred constructions for the sense electrode are shown in FIGS. 6, 7 and 8.

One method of implementing the sense electrode 18 is through a capacitive sensor that can detect to presence of a change in capacitance that is created by a human touch of a nearby object, such as detecting the touch of a human finger to a vending machine front 2 when the capacitive sensor is attached to the opposite (inside) surface of the vending machine front 2. One such capacitive sensor is an ATMEL QT100A charge transfer digital sensor and integrated circuit made by the Atmel Corporation of San Jose, Calif.

The vending machines 1 of FIGS. 3 and 4 have eight product sensor areas 12, such that there will be eight sense electrodes 18, e.g. one sense electrode 18 placed within each product sensor area 12.

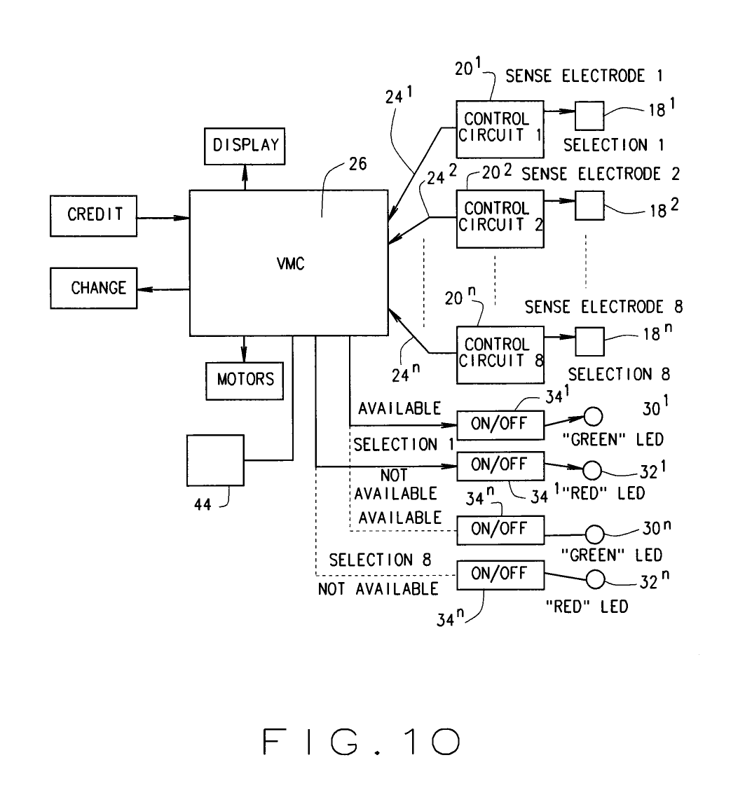

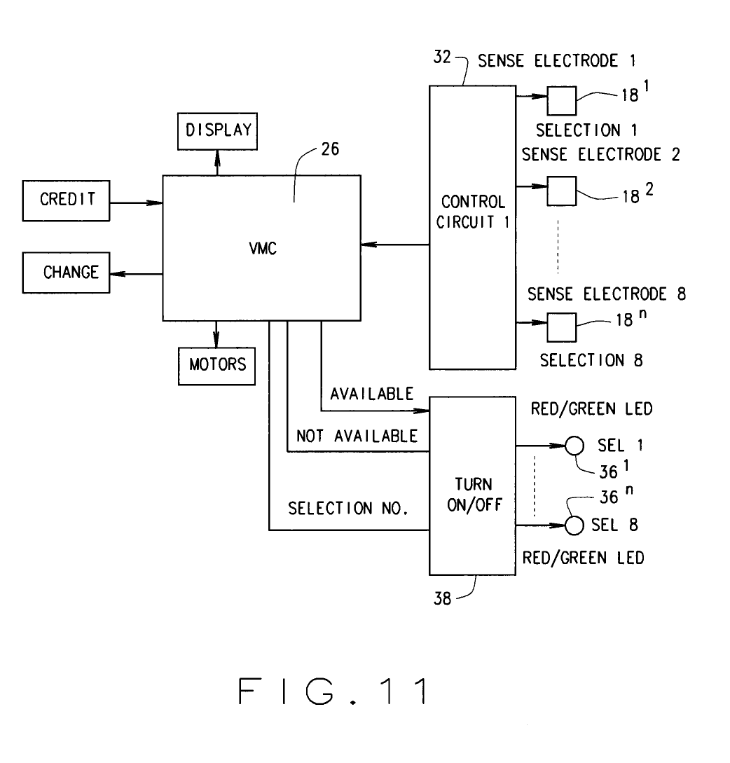

A block diagram representing the electrical construction of this physical arrangement is presented in the FIGS. 9 and 10. The sensitive area 14 of each product sensor area 12 comprises a sense electrode 18 and a control circuit 20. The control circuit comprises at least a line 22 for controlling the sense electrode and a line 24 for communicating with a vending machine controller 26. The control circuit 20 further is connected to a source of electrical power through a line 28. Each touch sensor's 18¹, 18², . . . , 18ⁿ and each control circuit 20¹, 20², . . . , 20ⁿ is connected to the vending machine controller 26 via lines 24¹, 24², . . . 24ⁿ.

Further, in association with each product sensor area 12 are LEDs 30ⁿ and 32ⁿ which indicate the presence or absence of the product represented by the product sensor area12 in the vending machine 1. Alternatively, the LEDs 30ⁿ and/or 32ⁿ may be used to illuminate the product selection area 12 when the product selection area is made from a translucent or transparent material and the presence or absence of illumination of the product selection area 12 indicate the present or absence of product from the vending machine 1. Furthermore, the vending machine can illuminate a portion of the product selection area 12 with a green or red light to provide an indication of availability of the product. Additionally, the vending machine can illuminate or de-illuminate a portion of the product selection area 12 and indicia on that portion product selection area 12 provide an indication of availability of non-availability when illuminated.

Finally, though not discussed in detail here and in accordance with the prior art, credit mechanisms, (credit card readers, coin acceptors, bill acceptors), change mechanisms (including change mechanisms dispensing banknotes and coins), displays and motors that provide other functionality of the vending machine communicate with the vending machine controller 26.

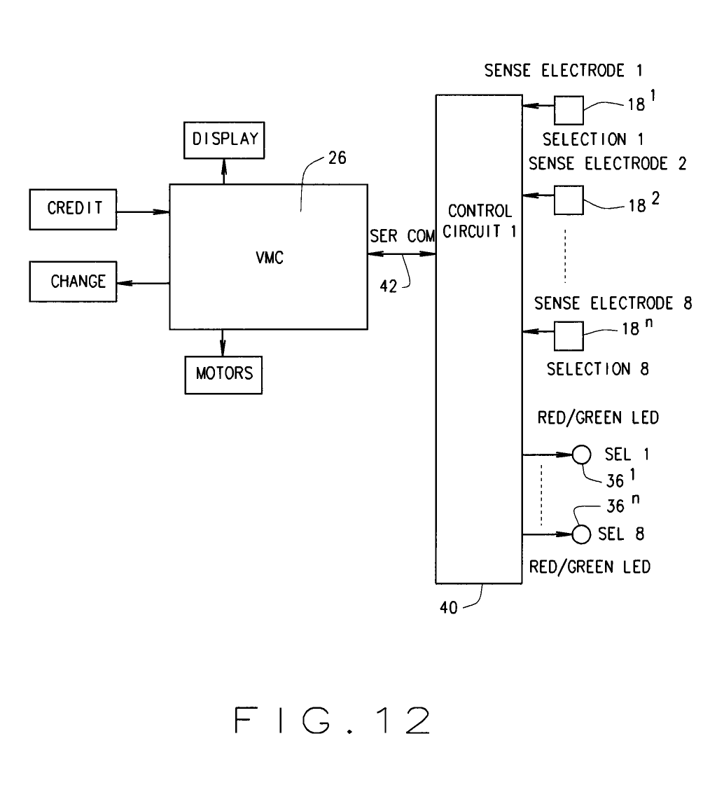

Alternative embodiments of the present invention are presented in FIGS. 11 and 12. In the design of FIG. 11, the individual control circuits control circuit 20¹, 20², . . . , 20ⁿ of FIG. 10 are replaced by a single control circuit 32 attached to each of the sense electrodes 18. The control circuit 32 communicates serially to the vending machine controller 26 which one of the electrodes sensed a product selection.

The circuit of FIG. 10 produces red or green illuminations to indicate product availability. Physically, on the inner side of each of solid front 2, the LEDS are mounted behind each product selection area 12 and maximize the light diffusion effect. When the vending machine controller 26 determines that the product corresponding to a specific location is not available, corresponding signals are sent to drivers 34¹, 34², . . . , 34ⁿ FIG. 10 and the red light is turned ON and the green light is turned OFF. Although LEDs are discussed and preferred, one of ordinary skill in the art will recognize that any source of illumination could be used.

Alternative methods of producing the illumination effect are illustrated in FIGS. 11 and 12. In these cases, individual red and green LEDs 30ⁿ are replaced with bicolor LEDs 36ⁿ and a single driver 38 for selectively driving all of the LEDs 36ⁿ. The driver 38 communicates serially with the vending machine controller 26.

In FIG. 12, a driver 40 communicates serially to the vending machine controller 26 what product selection area 12 a customer touched. The vending machine controller 26 determines the availability of the product and illuminates the appropriate LED 36ⁿ using the appropriate line to indicate that a selection is available or not available. In the preferred approach of FIG. 12, the communication between the vending machine controller 26 and the sense electrodes 18 and the communication between the vending machine controller 26 and the LEDs 36ⁿ are only serially via a SER COM line 42 between the driver 40 and the vending machine controller 26 using an established protocol.

The sensors that comprise the sense electrode can comprise piezo-electric sensors, resistive sensors, inductive sensors, or Hall effect sensors that detect the proximity of a human body in contact, very-near proximity or minute deflection of the solid front of the vending machine within the product selection areas. The sensors can be described as a direct capacitor in which a capacitor which comprises only one charged plate is placed on the inside surface of the solid front of the vending machine. When a user touches the solid front of the vending machine in the product selection area, the user's finger essentially acts as the other plate of a capacitor to affect the capacitance rating of the capacitor and for the circuit to detect a product selection. The solid front acts as the dielectric. In an indirect type capacitor, the capacitor is a two plate capacitor. Small deflections of the solid front of the vending machine create distortions of the two plates and the dielectric separating them. The resulting change in capacitance from the deformation indicates that a product selection has been made. The sense electrode may also be a piezo-electric material.

Moreover, it is further contemplated that an audio driver 44 is provided to provide an audio feedback to the consumer indicating that a selection has been made.

The above examples show that the invention, as defined by the claims, has far ranging application and should not be limited merely to the embodiments shown and described in detail. Instead the invention should be limited only to the explicit words of the claims, and the claims should not be arbitrarily limited to embodiments shown in the specification. The scope of protection is only limited by the scope of the accompanying claims, and the Examiner should examine the claims on that basis.

What is claimed is:

1. A method of receiving a product selection in a vending machine comprising the steps of:
providing a vending machine having a solid front, said solid front having an inner and outer surface;
defining a plurality of product selection areas in conjunction with front surface, each of the product selection areas associated with a product vendable by said vending machine;
placing a plurality of sense electrodes on the inner surface of the solid front of the vending machine, each of said electrodes associated with one of the product selection areas, wherein the sense electrodes are physically isolated from the outer surface of the solid front by the solid front;
providing a circuit electrically connected to at least one of the sense electrodes for determining whether a customer has contacted the outer surface of the vending machine front within one of the product selection areas and communicating information indicating that a product selection area has been touched to a vending machine controller; and
vending a product that corresponds to the touched product selection area.

2. The method of claim 1 further comprising the step of providing a graphic depiction of the product to be vended within the product selection area.

3. The method of claim 1 further comprising the step of providing an audible indication that a product selection has been made.

4. The method of claim 1 further comprising the step of communicating the absence or presence of available products corresponding to products of each product selection area by illuminating an indicator located within the product selection area.

5. The method of claim 1 further comprising the step of communicating the absence or presence of available products corresponding to products of each product selection area by illuminating or de-illuminating the product selection area.

6. The method of claim 1 further comprising the step of communicating the absence or presence of available products corresponding to products of each product selection area by illuminating the product selection area in a first color indicative of the presence of available product associated with the product selection area and illuminating the product selection area in a second color indicative of the absence of available product associated with the product selection area.

7. A vending machine comprising:
a solid front, said solid front having an inner and outer surface;
a plurality of product selection areas in conjunction with front surface, each of the product selection areas associated with a product vendable by said vending machine;
a plurality of sense electrodes on the inner surface of the solid front of the vending machine, each of said electrodes associated with one of the product selection areas, wherein the sense electrodes are physically isolated from the outer surface of the solid front by the solid front;
a circuit electrically connected to at least one of the sense electrodes for determining whether a customer has contacted the outer surface of the vending machine front within one of the product selection areas and communicating information indicating that a product selection area has been touched to a vending machine controller; and
vending a product that corresponds to the touched product selection area.

8. The vending machine of claim 7 further comprising a graphic depiction of the product to be vended within the product selection area.

9. The vending machine of claim 7 further comprising audio driver for providing an audible indication that a product selection has been made.

10. The vending machine of claim 7 further comprising a light source in communication with the vending machine controller located within the product selection area that is controlled by the vending machine controller to illuminate when product associated with the product selection area is either present or absent from the vending machine.

11. The vending machine of claim 7 further comprising a light source in communication with the vending machine controller to illuminate or de-illuminate the entire product selection area to indicate when product associated with the product selection area is available or is not available within the vending machine.

12. The vending machine of claim 7 further comprising a light source in communication with the vending machine controller to illuminate the entire product selection area in a first color to indicate when product associated with the product selection area is available within the vending machine and in a second color to indicate when product associated with the product selection area is not available within the vending machine.

13. The vending machine of claim 7 wherein the sense electrode comprises a plate of the and the solid front comprises a capacitor dielectric and the customer's finger alter the capacitance of the sense electrode when it comes into proximity of the production selection area.

14. The vending machine of claim 7 wherein the sense electrode comprises a two plate capacitor attached to the inner surface of the solid front wherein the capacitance is altered when the solid front is deflected to indicate a selection has been made.

15. The vending machine of claim 7 wherein the sense electrode is piezo-electric capacitor.

16. A refrigerated solid front vending machine comprising:
product selection areas associated with an outer surface of said solid front vending machine for a customer to touch for selecting a product, the product identification areas being unitary with said solid front;
a sensor attached to an inside surface of each of the product selection areas that produces a signal indicative of said touch by a customer;
a controller operatively connected to the said sensor to register the signal by the said sensor when a touch occurs and indicating which of the product selection areas was touched, and dispensing said product if credits equal to or exceeding a cost of the product have been deposited.
